(19) United States
(12) Patent Application Publication
(10) Pub. No.: US 2016/0307154 A1
(43) Pub. Date: Oct. 20, 2016

(54) INVENTORY MANAGEMENT AND CONTROL APPARATUS

(71) Applicant: BeWhere Inc., Toronto (CA)

(72) Inventors: Owen Robert Moore, Mississauga (CA); Christopher John Panczuk, Brampton (CA)

(21) Appl. No.: 15/130,434

(22) Filed: Apr. 15, 2016

Related U.S. Application Data
(60) Provisional application No. 62/147,930, filed on Apr. 15, 2015.

(51) Int. Cl. G06Q 10/08; H04W 4/02; H04W 8/00; H04W 4/00

(52) U.S. Cl. CPC G06Q 10/0833; H04W 4/008; H04W 4/02; H04W 8/005; G06Q 10/0838; H04W 84/18

(57) ABSTRACT

An asset tag apparatus and method of monitoring assets uses a wireless communication protocol to generate and transmit output values of sensors coupled to a beacon within a transmission range to a computing device. The advertising message of the wireless communication protocol is transmitted when a sensor output exceeds a threshold or on periodic time basis. Historic sensor data occurring at consecutive sensor threshold exceeding events is interleaved with live sensor output data in consecutive advertising packets.

### CROSS REFERENCE TO RELATED APPLICATION

This application claims priority to U.S. provisional patent application Ser. No. 62/147,930, filed Apr. 15, 2015, the entire contents of which are incorporated herein in its entirety.

### BACKGROUND

The present inventory management and control apparatus relates, in general, to methods and apparatus for tracking assets and, particularly, to methods and apparatus for monitoring the conditions of assets during a tracking period.

Companies and parties who ship products and goods place importance on tracking the location of products and goods during transport, when stored in warehouses, or when sitting at use site. Such companies and parties prefer to know the environmental conditions that act on such products and goods during transport, storage, etc., to ensure that the products and goods reach the end user in good condition.

Wireless short range RF tags have been applied to goods for wirelessly communicating sensor measurements for humidity, temperature, acceleration, moisture, and magnetic fields to a receiver located within the transmission range of the tag or beacon. Bluetooth protocol has been employed with such tags to enable the transmission and receiving of the beacon message. Bluetooth receivers are constructed as part of or are coupled to a network for communicating the sensor information to the interested party.

### SUMMARY

Battery life is an issue with such tags or wireless beacons. To conserve energy, such tags or beacons have a wake-up mode wherein the tag is activated from a sleep mode when a sensor output exceeds a threshold or on a periodic time basis. However, in this situation, any sensor data during the sleep mode is lost. Improved asset management tags and beacons are desirable.

One portable beacon mountable on an asset as described herein includes a processor based Bluetooth communication module, and at least one sensor responsive to external and ambient conditions coupled to the communication module. The at least one sensor has an output. The communication module transmits a beacon message using wireless communication protocol to a transmission area within the transmission range of the beacon generating device for reception by at least one computing device located in the transmission area, each transmission including an indication of the location of the module and at least one sensor output in a single advertising data packet. The communication module transmits an advertising channel containing at least one sensor output when the at least one sensor output exceeds a preset threshold, and interleaves transmitted advertising packet with historic data of the same at least one sensor.

The communication module can store a live sensor output value exceeding a threshold as historic sensor data. The communication module transmits at least one historic sensor data associated with one sensor along with live sensor data associated with the at least one sensor in the same advertising channel of the beacon message.

In some implementations, the communication module stores consecutive sensor output data exceeding thresholds as a plurality of consecutive historic sensor data. The communication module transmits a plurality of the stored historic sensor data along with live sensor data in a single adverting channel beacon message.

The at least one sensor may be at least one of an accelerometer sensor, a temperature sensor or a light sensor.

In some implementations, the communication module transmits a plurality of consecutive advertising channel beacon transmissions containing the historic data.

The communication module can start an elapsed timer when a live sensor output value exceeds a threshold to track elapsed time since the occurrence of historic data corresponding to sensor output value exceeding a threshold.

In some implementations, the communication module transmits consecutive live data and historic data for a predetermined number of advertising channel transmissions.

The predetermined number of advertising channel transmissions can each include a plurality of prior consecutive historic data.

A plurality of sensors can be coupled to the housing, each responsive to a different exterior or ambient event.

In some implementations, the communication module stores as live data and historic data sensor output values exceeding a threshold associated with a sensor.

The communication module can transmit a plurality of historic data with live data in one advertising channel transmission.

The communication module transmits a plurality of consecutive historic data and one live data in one advertising channel. The communication module transmits a plurality of consecutive historic data and live data of a different one of a plurality of sensors.

The beacon can form part of an asset management and control apparatus. An application control program executed by a processor based apparatus receives a Bluetooth advertising channel data packet from the beacon of the communication module containing sensor data. The processor transmits the advertising channel data packet to a server executing control program instructions to identify the beacon and the asset associated with the beacon.

A method for attaching a processor based Bluetooth communication module to an object described herein includes disposing at least one sensor responsive to external and ambient conditions of module with the object, transmitting by the communication module a beacon message using wireless communication protocol to a transmission area within the transmission range of the beacon generating device for reception by at least one computing device located in the transmission area, each transmission including an indication of the location of the module and at least one sensor output in a single advertising data packet, transmitting by the communication module an advertising signal containing at least one sensor output when the at least one sensor output exceeds a preset threshold, and interleaving transmitted advertising packet with historic data of the same at least one sensor.

The method may also include storing by the communication module a live sensor output value exceeding a threshold as historic sensor data, and transmitting by the communication module at least one historic sensor data associated with one sensor along with live sensor data associated with the at least one sensor in a same advertising channel of the beacon message.

In some implementations, the method further includes storing by the communication module consecutive sensor output data exceeding thresholds as a plurality of consecutive historic sensor data, and transmitting by the communication module a plurality of the stored historic sensor data along with live sensor data in a single adverting channel beacon message.

In the method, the at least one sensor can be at least of an accelerometer sensor, a temperature sensor, or a light sensor.

The method may also include the communication module transmitting a plurality of consecutive advertising channel beacon transmissions containing the historic data.

In some implementations, the method further includes the communication module starting an elapsed timer when a live sensor output value exceeds a threshold to track elapsed time since the occurrence of historic data corresponding to the live data of a sensor output value exceeding a threshold.

The communication module transmitting consecutive live data and historic data for a predetermined number of advertising channel transmissions may also be included in the method.

The method can include a predetermined number of advertising channel transmissions, each including a plurality of prior consecutive historic data.

In some implementations, the method includes a plurality of sensors, each responsive to a different exterior or ambient event.

The method can include the communication module storing as live data and historic data sensor output value exceeding a threshold associated with a sensor.

The method can also include the communication module transmitting a plurality of historic data with live data in one advertising channel transmission.

In some implementations, the method includes the communication module transmitting a plurality of consecutive historic data and one live data in one advertising channel, and the communication module transmitting a plurality of consecutive historic data and live data of a different one of a plurality of sensors.

The various features, advantages, and other uses of the teachings herein will become more apparent referring to the following description and drawing.

### BRIEF DESCRIPTION OF THE DRAWING

The description herein makes reference to the accompanying drawings described below wherein like reference numerals refer to like parts throughout the several views.

FIG. 1 is a perspective view of an asset management and control apparatus according to the teachings herein.

FIG. 2 is a schematic diagram of the electronic circuitry contained within the housing shown in FIG. 1.

FIG. 3 is a block diagram depicting the major components of the apparatus.

FIG. 4 is a block and flow diagram of the apparatus architecture.

FIG. 5 is a pictorial representation of a Bluetooth data packet employed by the apparatus that can be transmitted from, e.g., a smartphone to a database.

FIG. 6 is a pictorial representation of the functionality of the apparatus, including beacons.

FIG. 7 is a flow chart depicting the collection and the transmission of live and historic sensor data.

### DETAILED DESCRIPTION

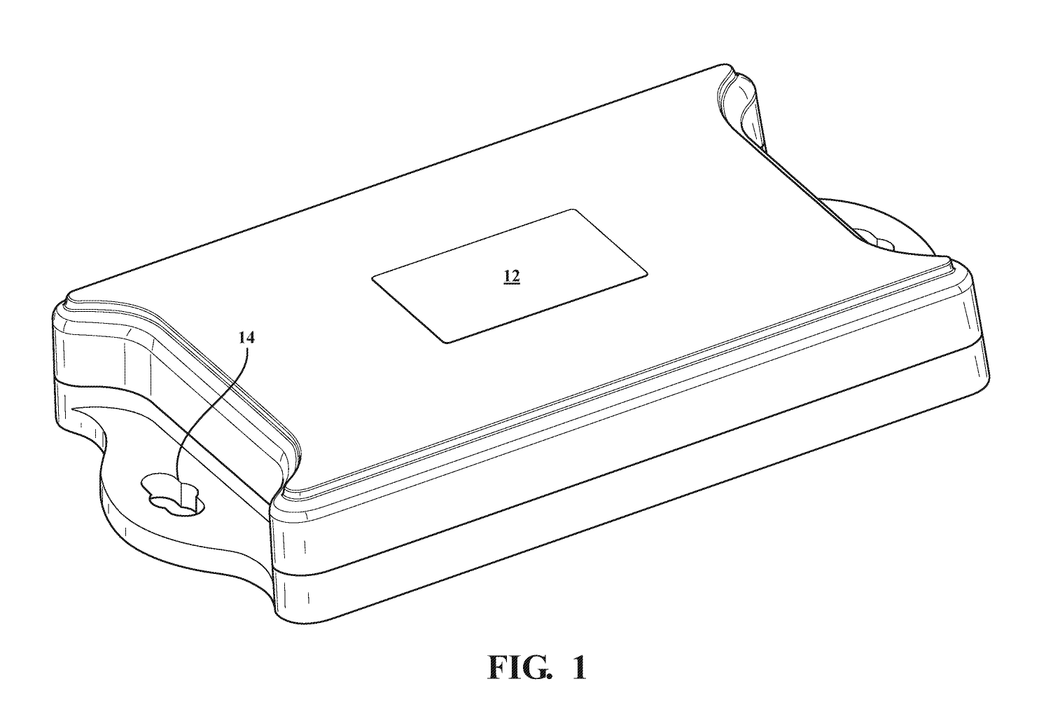

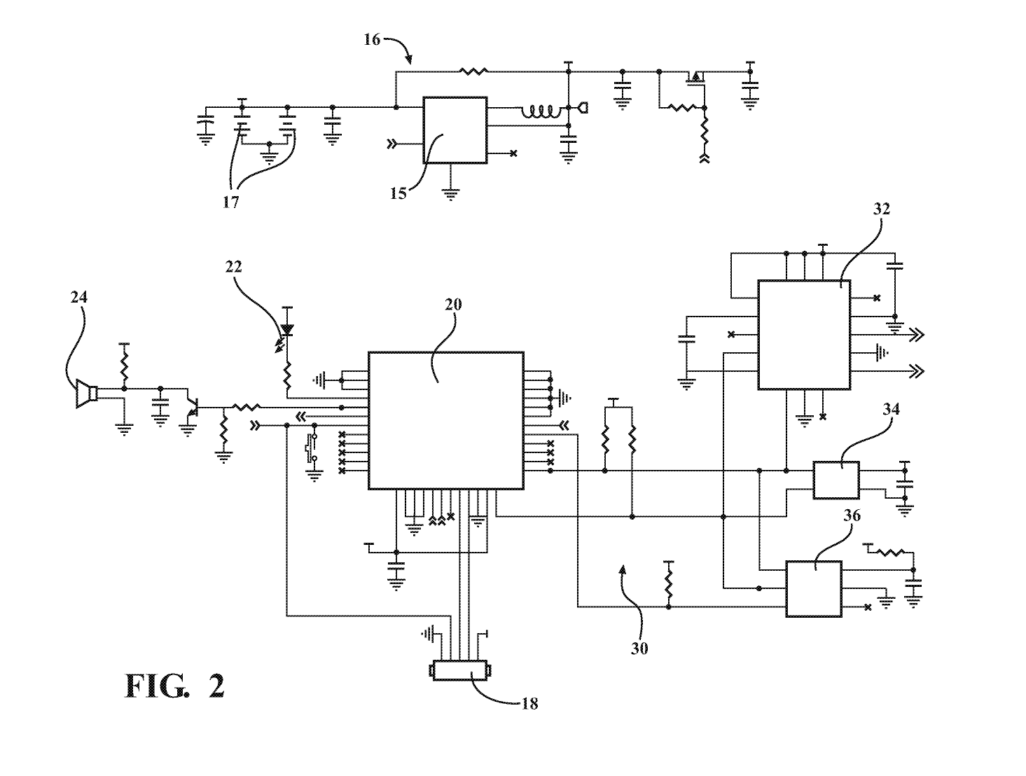

Referring to FIGS. 1-7, there is depicted an asset or inventory management and control apparatus 10. The apparatus 10 includes a housing 12, which can be approximately the size of a matchbox. The housing 12 is formed of a suitable electronics compatible material, and may have one or more mounting apertures 14 for fixedly, yet removably, attaching the housing 12 to a product to be monitored by the apparatus 10. The housing 12 contains electronic circuitry that is shown in detail in FIG. 2.

The circuitry includes a power supply 16 utilizing a step down DC-DC converter 15, which supplies DC power to a terminal plug/socket 18 and to one or more sensors as described hereafter. The DC-DC converter 15 receives power from one or more batteries 17.

The electronic circuitry also includes a Bluetooth smart long range module 20.

The Bluetooth smart long range module 20 forms a low energy radio capable of transmitting signals over a short distance of approximately 250 meters, depending upon buildings, etc., in the surrounding environment.

The module 20 powers a light emitting diode 22 that forms a visual alarm viewable exteriorly of the housing 12. The module 20 also powers an audible alarm 24 in the form of a buzzer, for example.

An I²C communication bus 30 connects inputs of the Bluetooth smart long range module 20 from a plurality of sensors, such as an accelerometer 32, temperature sensor 34, and an ambient light/infrared, for example, light sensor 36 mounted in or carried on the housing 12. Any or all of the sensors 32, 34 or 36 may be employed with the Bluetooth module 20. It will also be understood that other types of sensors, such as a moisture sensor, a magnetic field sensor, a proximity sensor, etc., may also be employed.

The Bluetooth module 20 has a transmitter that uses short wave length radio frequency transmission in the 2.4 GHz to 2.485 GHz range. The Bluetooth module 20 may include various electrical components for use with the sensors 32, 34 and 36. For example, one or more microprocessors, read only and/or random access memories, a battery, a circuit board, a wireless modem, a Global Positioning System (GPS) module and various input/output interfaces maybe provided to facilitate wireless communication and signal transmission between the Bluetooth module 20 and the external receiver coupled network.

The I²C communication bus 30 is optimized (to save battery power) such that it is active only to read/write information from the sensors when sensors have relevant data such as when sensor values exceed or meet a defined threshold/event for impact, motion or free fall (accelerometer), ambient/infrared light level or temperature level. The I²C communication bus 30 is also optimized to be active (to save battery life) on a time basis (e.g., every “x” minutes) to read output of the temperature sensor 34 and light sensor 36. Once the data is read/write, the I²C bus 30 is immediately de-activated until the next threshold event or time basis.

The accelerometer 32 can be a three axis Bluetooth 14-bit resolution accelerometer having an output supplied to the Bluetooth Smart long range module 20.

The temperature sensor 34 can be a temperature sensor having a digital output supplied to the long range module 20.

The light sensor 36 may be an ambient light/infrared light to digital converter sensor for detecting ambient light/infrared light impacting the housing 12.

The sensors 32, 34 and 36 continue to record and store data, but the data is only sent to the Bluetooth module 20 over the I²C communication bus 30 when any sensor 32, 34 and 36 output reaches a threshold (i.e., the G-force is greater than X, the temperature is greater than or less than Y, etc.) or an event is triggered (i.e., motion is detected, freefall is detected, etc.), or on a time defined threshold, such as read current temperature every 10 minutes.

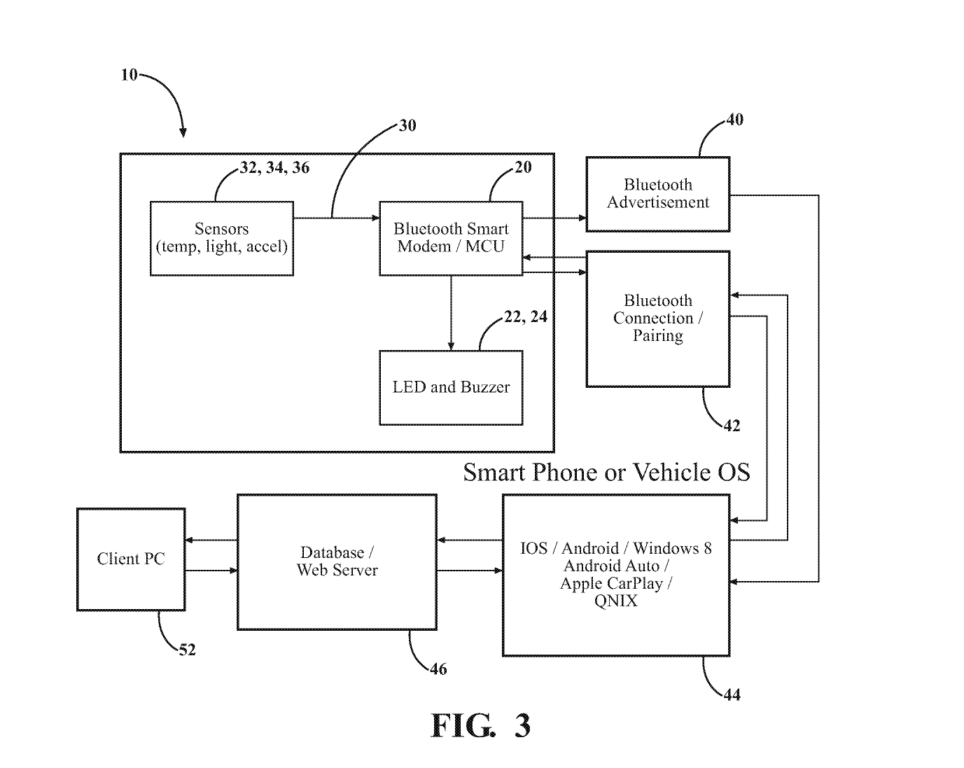

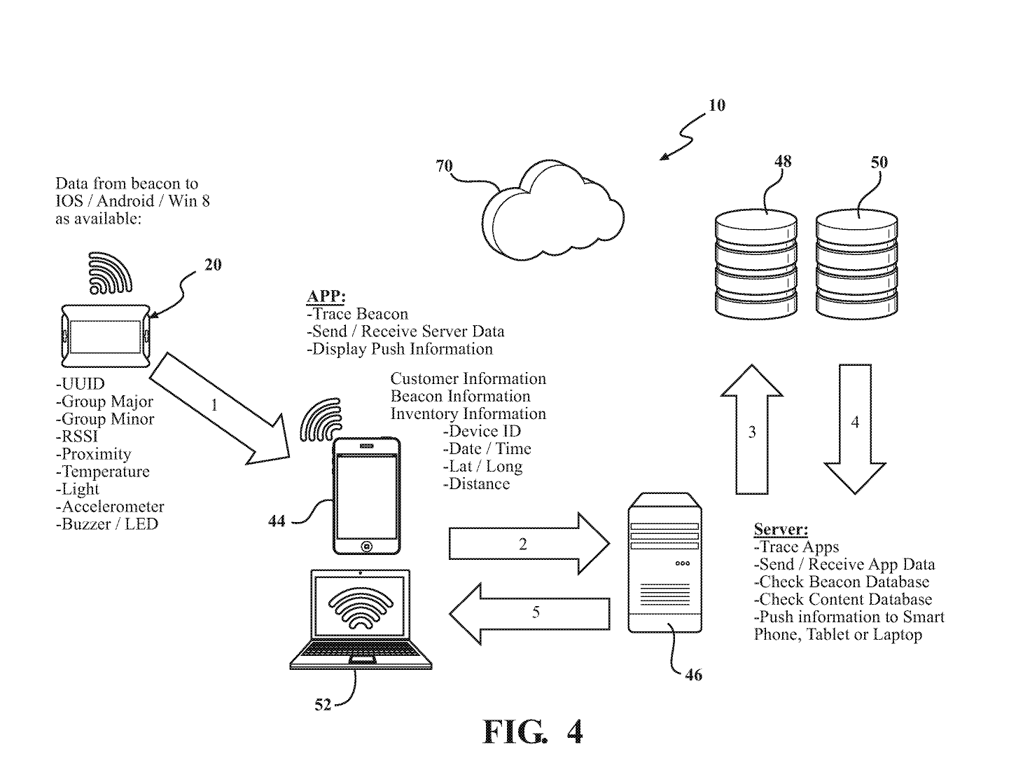

Referring now to FIGS. 3 and 4, there is depicted a block diagram and pictorial representation of the overall apparatus 10.

The module 20 generates a Bluetooth advertisement data packet 40 once every pre-settable interval, such as 10 times per second, once every second, etc., with longer intervals corresponding to reduced battery power requirements.

The Bluetooth module 20, hereafter also referred to as the beacon 20, uses 31-byte advertising packets to transmit the current state of the beacon 20 and the coupled sensors 32, 34 and 36. Appendix A depicts a byte structure that can be used, by example, in the beacon 20. The following packet types may be used:

PACKET_DATA_STANDARD=0

PACKET_DATA_LIVE=1

PACKET_DATA_HISTORIC_[ABC]

Standard and live packets are available in each transmitted advertisement. Unique historic packets are interleaved with the standard and live packets. For example, historic packets are cycled every one minute. With an advertising interval of approximately one second, 60 consecutive advertisements are employed to capture historically interleaved data. The values of each sensor 32, 34 and 36 are set forth below. The historic timestamp may be a 16-byte unsigned value (LSB, MSB) representing “time (minutes) since (event)” with respect to the current time. The timestamp will max out at a fixed date, such as 45 days for example.

Updated historic packets can be distinguished by the number 1-byte frame ID, which is incremented every time any historic data has been changed. This incrementing includes when the timestamp is updated (e.g., every minute), or when a threshold event has occurred, e.g., an impact was detected.

There is no guarantee that only exactly one frame ID increment has occurred between consecutive advertisements. For example, in one situation, an impact is detected and the temperature threshold is exceeded within the same one second advertising interval. This may result in a frame ID jump of two between consecutive advertisements.

Historic packet types are doubly-functional. The historic packet types identify the type of historic packet, as well as providing extra information about the nature of the historic data. The base packet types are as follow:

PACKET_DATA_HISTORIC_IMPACT=0

PACKET_DATA_HISTORIC_TEMPERATURE=1

PACKET_DATA_HISTORIC_LIGHT=2

Additionally, the upper nibble is a bit-mass representing whether the historic events are values are coming in-band (back within the thresholds) or out-of-band (exceeding thresholds). An in-band bit is 1, and an out-of-band bit is 0 with a bit-mask of:

0b0001000—Value 0 in/out of band

0b0010000—Value 1 in/out of band

0b0100000—Value 2 in/out of band

0b1000000—Value 3 in/out of band

For example, a historic type of 0b01010001 would represent temperature readings where the most recent reading (Value 0) and Value 3 have come back in-band (e.g., the values return to a “good” value within the specified thresholds).

An example of an impact data counter is:

Advdata(12:1)=xx # Impact Counter

The live impact counter represents how many times the x, y or z axes have experienced accelerations exceeding a threshold (default at 2 g). The counter is stored as a UINT8 data type having values from 0-255, and then rolling over back to zero.

On beacon 20 reset, the live impact counter sets to zero. The live impact counter is updated immediately after an impact occurs.

Historic impact values are represented as the value of the threshold which was crossed, and how many minutes it has been since that threshold was crossed in the x, y or z axes. The threshold value is represented in LSB where 1LSB=0.063 g.

The live temperature data is expressed as follows:

Advdata(13:1)=xx # Temperature

The live data shows the current temperature in degrees Celsius. The live temperature data is stored as sint8, with values between −127 and +128. In practice, for the temperature sensor 34, the lowest temperature the beacon 20 can reach is approximately −40 degrees C. and the highest temperature can be approximately 80 degrees C.

When the beacon 20 is reset, the current temperature register is populated with a constant 22 degrees as an initialization. The beacon 20 takes temperature readings at approximately 1 minute intervals.

Historic temperature values are represented as the value of the threshold that was crossed, and how many minutes it has been since that threshold was crossed (both high and low threshold crossings). A historic value is generated when the temperature both goes out of the thresholds, and when it comes back within the thresholds. Default beacon 20 thresholds are 5 and 28 degrees in the implementation shown.

For example, with an upper threshold of 22 degrees C. and lower threshold of 16 degrees C., live temperature measurements (at 1 minute intervals) such as: 18, 21, 22, 24, 27, 21, 20, 17, 15. 20, 24, will generate the following historic values.

Value0: 22—Time0:1 minute ago

Value1: 16—Time1:2 minute ago

Value2: 16—Time2:3 minute ago

Value3: 22—Time3:6 minute ago

The live light data is represented as follows:

Advdata (14:1)=xx # Light

The live light data shows the current light readings. It is stored as uint5 with values between 0 and 255. The light sensor 36 is preset with a full-scale range of 16000LUX.

When the beacon 20 is reset, the current light register is populated with a constant 4 LSB as an initialization. The beacon 20 can takes light readings at preset periodic intervals, such as approximately 1 minute intervals.

Historic light values are represented as the value of the threshold which was crossed, and how many minutes it has been since that threshold was crossed including both high and low threshold crossings. A historic value is generated when the light reading both goes out of one of the thresholds, and when it comes back into one of the thresholds. Default beacon thresholds may be 2 and 8 LSB.

The beacon 20 battery level is shown as:

Advdata (9:1)=xx # Battery Level

The battery level is represented as the approximate state of the battery in percent, it is read as a value between 0-100.

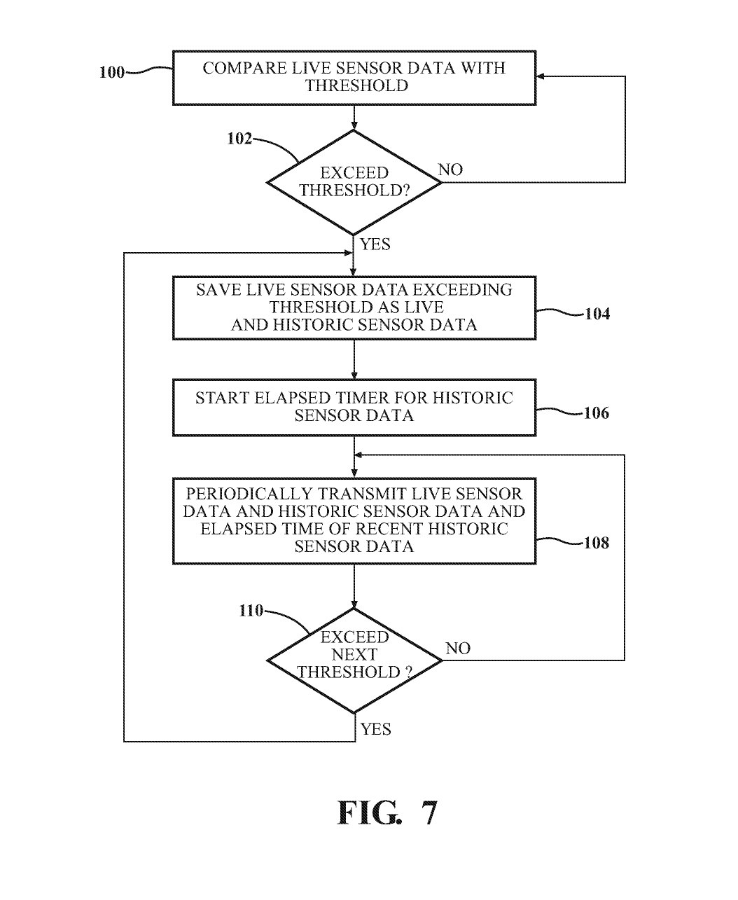

Referring now to FIG. 7, there is depicting a flow chart of the data collection and data transmission process for the beacon 20. For clarity, the sequence shown in FIG. 7 is depicted for a single sensor coupled to the beacon 20. It will be understood that the same sequence of operation applies when multiple sensors such as, any or all of the sensors 32, 34 and 36 described above, are coupled to the beacon 20.

In step 100, the beacon 20 compares live sensor 32, 34 and 36 output data with all of the thresholds for each sensor, as described above. For example, the temperature sensor 34 and the ambient light sensor 36 have two thresholds each, characterized as a high threshold value and low threshold value, as described for example above. The accelerometer 32 has a single threshold defining an impact force. The beacon 20 continually compares the live sensor data with all of the thresholds associated with a particular sensor to detect when the sensor output value exceeds one threshold in step 102.

The beacon 20 then saves, in step 104, the live sensor data that exceeds the threshold for a particular sensor as live sensor data and as historic sensor data. The beacon 20 also starts an elapse timer in step 106 coupled to the historic sensor data that, as described hereafter, will define how much time as elapsed since the occurrence of the recorded historic sensor data.

The beacon 20 then periodically transmits the live sensor data associated with a threshold being exceeded as well as the current sensor data occurring thereafter, and the historic sensor data and the elapsed time since the occurrence of the historic sensor data in step 108.

The beacon 20, in step 110, continues to monitor the sensor or sensors to detect when a next threshold is exceeded. When this occurs, the beacon 20 repeats steps 104 and 106 while keeping the multiple historic sensor data and the associated elapse time as separate historic sensor data entries. Multiple historic sensor data and elapse time values are then transmitted with the ongoing live sensor data in step 108.

This sequence of transmitting in the advertising channel live sensor data after a sensor output value has exceeded a threshold along with one or a plurality of historic sensor data and elapse time information since any threshold is exceeded continues. For example, four historic sensor data may be stored for each sensor 32, 34 and 36. When a fifth sensor threshold value is detected, the beacon 20 overwrites the oldest historic sensor data and timer information with the most recent historic sensor data and its associated elapsed time.

The interleaving of historic data and live data overcomes the difficulty encountered with prior asset tags where a sensor associated with such an asset tag may have an output value exceeding a threshold at time when the beacon 20 is not within range of a receiving device, such as a mobile phone. This threshold exceeding event will then be lost.

The present apparatus and method overcomes this difficulty by storing a plurality of historic sensor data as well as the elapsed time since the occurrence of each sensor data that is associated with a threshold being exceeded, as part of consecutive advertising channel transmissions. For example, the present apparatus and method may transmit the plurality of historic sensor data and associated elapsed time for a number of consecutive advertising channel transmissions, such as 60 transmissions in one implementation. The beacon 20 then transmits the historic data associated with another sensor coupled to the beacon 20 for the next 60 transmissions, followed by transmission of the historic sensor data associated with the third sensor coupled to the beacon 20 for the next 60 transmissions.

It will be understood that the 60 consecutive cycle transmissions of the historic sensor data associated with a single sensor can be treated as a variable, and the historic data may be transmitted from as few as one cycle to more than 60 cycles.

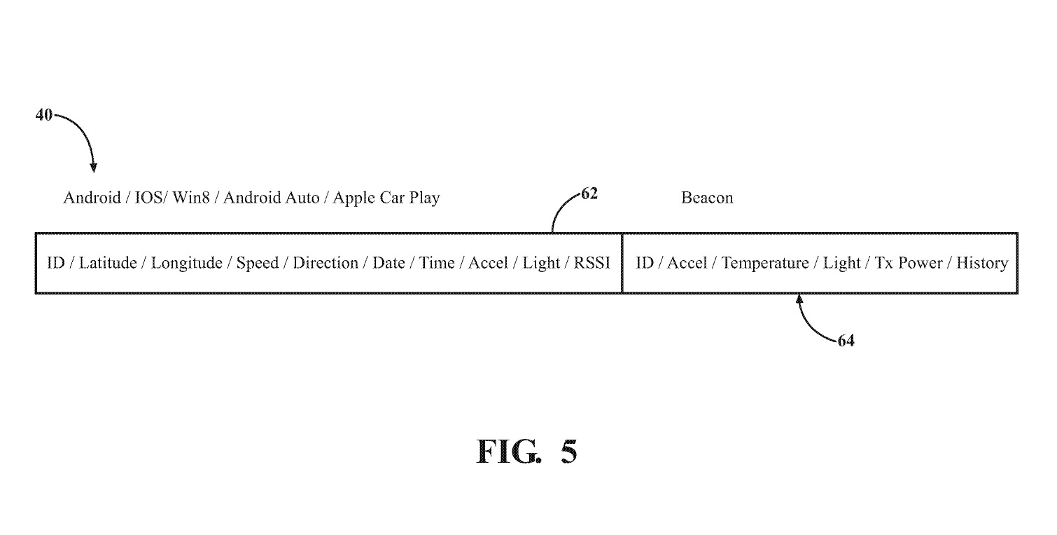

Without the requirement for a Bluetooth connection and pairing 42, and as shown in FIGS. 3-7, the beacon 20 may transmit the Bluetooth advertisement data packet 40 to a receiving device 44, which may be mobile receiving device 44 such as a smart phone or a vehicle operating system compatible with IOS/Android/Windows/Android Auto/Apple CarPlay/QNIX or any other in-vehicle operating system. An app in the smart phone or other in vehicle operating system 44 receives the Bluetooth advertisement data packet 40. As shown in FIG. 5. the advertisement data packet 40 includes standard Bluetooth information and MAC ID, TxPower, etc., and sensor data such as Acceleration (g-force, motion, freefall), temperature, and ambient and infrared light level, and is paired with data from the smart phone or a vehicle operating system, such as date, time, latitude, longitude, speed, direction, and additional sensor information from the smart phone or vehicle operating system or other in-vehicle operating system.

The use of the Bluetooth advertising data packet 40 to include the sensor data optimizes battery life since the Bluetooth connection and pairing 42 tend to draw more battery power. The use of the advertising data packet 40 to transmit sensor information also enables a maximum range to be obtained from the beacon 20 because it is a one-way communication and therefore the distance that the advertisement data packet 40 can travel is not dependent upon the mobile receiving device (e.g., a smart phone) 44, as only the beacon 20 determines the range.

The advertisement data packet 40 along with the appended data from the smart phone, vehicle operating system, or other in-vehicle operating system is wirelessly transmitted via smart phone or vehicle operating system or other in-vehicle operating system communication protocol, wirelessly via the cloud 70 to a server 46 in the inventory management control apparatus 10. The server 46 communicates with a beacon database 48 and a content database 50. The server 46 also checks the beacon database 48 and the content database 50 for any smart phones or vehicle operating systems 44 requesting information. The service 46 then pushes or transmits the requested information to the mobile receiving device 44 or other wireless communication processor based device, such as a tablet or a user computer 52, which may be a desktop, laptop, or other computing device.

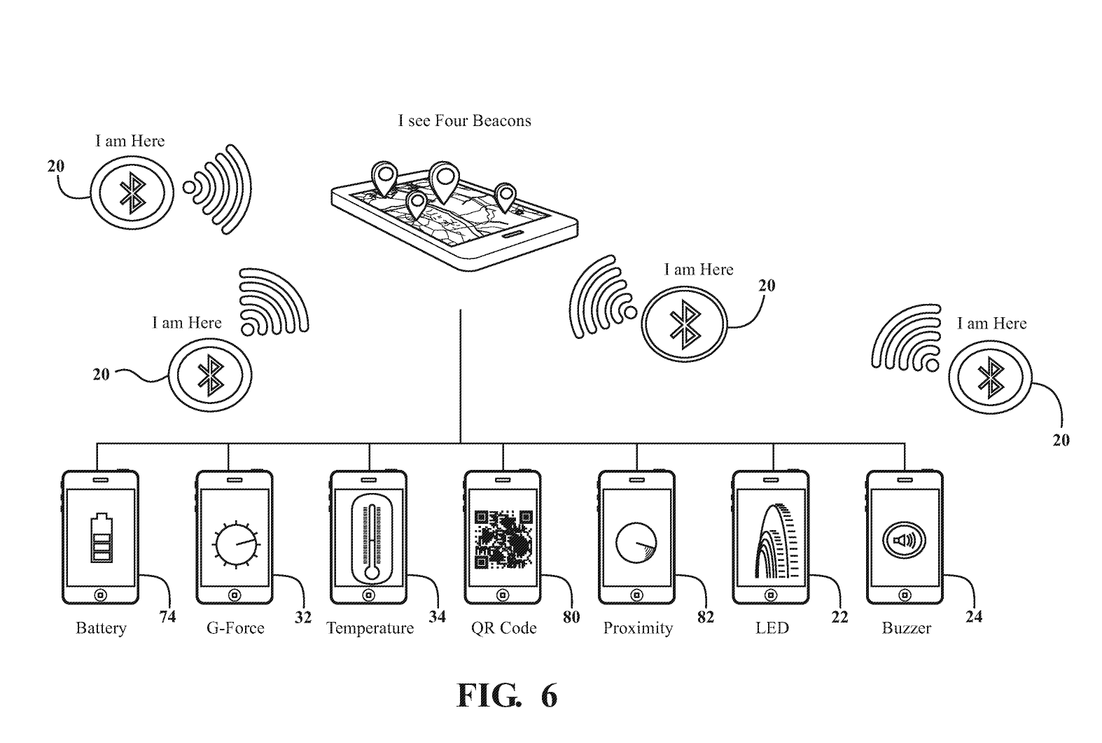

FIG. 6 depicts the types of information that can be displayed on the mobile receiving device 44 or a user computer 52 monitor. As shown in FIG. 6, the battery life 74 may be displayed. The outputs of the accelerometer 32, the temperature sensor 34, or the light sensor 36 may also be displayed along with the barcode or QR code 80 and the date/time on the goods or product on which the beacon 20 is mounted. The LED 22 and buzzer 24 status of the beacon 20 can also be displayed along with a proximity indication 82 depicting the distance between the user mobile receiving device 44 and the beacon 20.

The inventory and control management apparatus 10 may be employed in a variety of applications to provide a widely diverse range of applications. The beacon 20 can be attached to inventory that has been assigned to a specific vehicle, geographical location or area within a building or site. The smart phone and app, along with the apparatus 10, can determine the proximity of the inventory through distance measurements thereby enabling the beacon 20 on the attached goods to be located. The beacon 20 can also, upon command from the mobile receiving device 44, activate the visible light 22 and/or audible alarm or buzzer 24 to aid in locating the inventory. The output of the accelerometer 32, temperature sensor 34, or light sensor 36 may also be displayed along with the barcode or QR code 80 and the location and date/time 10 on the goods or products to which beacon 20 is mounted.

The location feature can also be employed to enable equipment to be located within a specific vehicle, building or job site. An equipment based map with location information can be used with the user's smart phone and/or computer 50 to display the location of the beacon 20 and the assigned goods.

The beacon 20 can also be employed in conjunction with the app and the mobile receiving device 44 to locate inventory to online mapping via Android, iOS, Windows, etc. Further, the beacon 20 and smart phone app can be used to locate the inventory, equipment and tools in buildings and job sites. The apparatus also enables automation of inventory pickup and drop off times and provides sensor (temperature, light, and accelerometer) information on the attached goods. The app via the mobile receiving device 44 can be programmed to receive automatic notifications to prevent inventory and equipment loss.

In a use of the beacon 20 on a vehicle, the beacon 20 can be employed to manage onboard vehicle inventory. The beacon 20, via the sensors 32, 34, 36, can provide time stamped information when the inventory is removed and returned to the vehicle. This can be used to provide real time location and notifications for equipment, structures, tools, meds, keys, radios, etc. The vehicle driver can be alerted if anything is missing when the driver moves the vehicle away from a site where the equipment was used. Such alerts can be via the mobile receiving device 44 in the form of visual or audible alerts. An email can also be programmed to be sent from the mobile receiving device 44 to a supervisor for missing item notification and last known location of the items.

The beacon 20 can also be used in large construction, rail and utility sites and assigned to equipment within specific geographical locations. This provides a real time 24/7 inventory monitoring and control. The beacon 20 can provide real time alerts on unauthorized movements of equipment and tools on which it is mounted. The beacon 20 can generate time base service of equipment and provide notification when the equipment was within range to perform such service. The beacon 20 can also be integrated to third party inventory management systems. The beacon 20 can be attached or built into pallets such that the pallet is tracked for location and monitored for adherence to transport and storage requirements.

The beacon 20 thus enables the automation of logs for start and end time, arrival and departure time, and driver comparison via number of trips per day, week or month and the time associated with each trip.

APPENDIX A
# Flags = LE General Discovery, single mode device (02 01 06)

| | |
|---|---|
| advdata(0:1) = $02 | # Length |
| advdata(1:1) = $01 | # Type |
| advdata(2:1) = $06 | # Data |
| # Manufacturer data | |
| advdata(3:1) = $1a | # Length |
| advdata(4:1) = $ff | # Type |
| # Manufacturer ID | |
| advdata(5:1) = $77 | # BeWhere ID 0x277 (in little endian) |
| advdata(6:1) = $02 | # BeWhere ID 0x277 (in little endian) |

# BeWhere proprietary data
advdata(7:1) = PACKET_DATA_STANDARD # Type (Standard packet)

| | |
|---|---|
| advdata(8:1) = $00 | # Category 1 |
| advdata(9:1) = $00 | # Battery level |
| advdata(10:1) = $c6 | # Tx Power |
| # Live packet data | |
| advdata(11:1) = PACKET_DATA_LIVE | # Type (Live Data) |
| advdata(12:1) = xx | # Impact Counter |
| advdata(13:1) = xx | # Temperature |
| advdata(14:1) = xx | # Light |
| advdata(15:1) = xx | # Unused |
| advdata(16:1) = xx | # Unused |
| # Interleaved, historic packet data | |

| | |
|---|---|
| advdata(17:1) = PACKET_DATA_HISTORIC_[ABC] | # Type |
| advdata(18:1) = xx | # Frame ID (0-255, repeats) |
| advdata(19:1) = xx | # Value 0 (most recent) |
| advdata(20:1) = xx | # Value 0 timestamp LSB |
| advdata(21:1) = xx | # Value 0 timestamp MSB |
| advdata(22:1) = xx | # Value 1 |
| advdata(23:1) = xx | # Value 1 timestamp LSB |
| advdata(24:1) = xx | # Value 1 timestamp MSB |
| advdata(25:1) = xx | # Value 2 |
| advdata(26:1) = xx | # Value 2 timestamp LSB |
| advdata(27:1) = xx | # Value 2 timestamp MSB |
| advdata(28:1) = xx | # Value 3 (oldest) |
| advdata(29:1) = xx | # Value 3 timestamp LSB |
| advdata(30:1) = xx | # Value 3 timestamp MSB |

What is claimed is:

1. A portable beacon mountable on an asset, comprising:
a processor based Bluetooth communication module;
at least one sensor responsive to external and ambient conditions of the module coupled to the communication module, the at least one sensor having an output;
the communication module transmitting a beacon message using wireless communication protocol to a transmission area within the transmission range of the beacon generating device for reception by at least one computing device located in the transmission area, each transmission including an indication of the location of the module along and at least one sensor output in a single advertising data packet; and
the communication module transmitting an advertising signal containing at least one sensor output when the at least one sensor output exceeds a preset threshold, and interleaving transmitted advertising packet with historic data of the same at least one sensor.

2. The portable beacon of claim 1, further comprising:
the communication module storing a live sensor output value exceeding a threshold as historic sensor data; and
the communication module transmitting at least one historic sensor data associated with one sensor along with live sensor data associated with the at least one sensor in a same advertising channel of the beacon message.

3. The portable beacon of claim 2, further comprising:
the communication module storing consecutive sensor output data exceeding thresholds as a plurality of consecutive historic sensor date; and
the communication module transmitting a plurality of the stored historic sensor data along with live sensor data in a single adverting channel beacon message.

4. The portable beacon of claim 1, wherein:
the at least one sensor is at least one of an accelerometer sensor, a temperature sensor, or a light sensor.

5. The portable beacon of claim 1, further comprising:
the communication module transmitting a plurality of consecutive advertising channel beacon transmissions containing the historic data.

6. The portable beacon of claim 1, further comprising:
the communication module starting an elapsed timer when a live sensor output value exceeds a threshold to track elapsed time since the occurrence of historic data corresponding to the live data of a sensor output value exceeding a threshold

7. The portable beacon of claim 1, further comprising:
the communication module transmitting consecutive live data and historic data for a predetermined number of advertising channel transmissions.

8. The portable beacon of claim 1, further comprising:
the predetermined number of advertising channel transmission each including a plurality of prior consecutive historic data.

9. The portable beacon of claim 1, wherein the at least one sensor comprises:
a plurality of sensors, each responsive to a different exterior or ambient event.

10. The portable beacon of claim 9, further comprising:
the communication module storing as live data and historic data sensor output value exceeding a threshold associated with the sensor.

11. The portable beacon of claim 10, further comprising:
the communication module transmitting a plurality of historic data with live data in one advertising channel transmission.

12. The portable beacon of claim 10, further comprising:
the communication module transmitting a plurality of consecutive historic data and one live data in one advertising channel; and
the communication module transmitting a plurality of consecutive historic data and live data of a different one of a plurality of sensors.

13. An asset management and control apparatus, comprising:
a beacon attachable to an article, the beacon including a Bluetooth communication module and at least one of an accelerometer, a temperature, or a light sensor; and
an application control program executed by a processor based apparatus for receiving a Bluetooth communication module advertising data packet from the beacon.

14. The asset management and control apparatus of claim 13, further comprising:
the processor transmitting the data packet to a server executing control program instructions to identify the beacon and the asset associated with the beacon, the processor transmitting data associated with the data packet to the sensor.

15. A method for managing an asset, comprising:
attaching a processor based Bluetooth communication module to an object;
coupling at least one sensor responsive to external and ambient conditions of the module to the module;
transmitting by the communication module a beacon message using wireless communication protocol to a transmission area within the transmission range of the beacon generating device for reception by at least one computing device located in the transmission area, each transmission including an indication of the location of the module and at least one sensor output in a single advertising data packet; and
transmitting by the communication module an advertising signal containing at least one sensor output when the at least one sensor output exceeds a preset threshold, and interleaving transmitted advertising packet with historic data of the same at least one sensor.

16. The method of claim 15, further comprising:
storing by the communication module a live sensor output value exceeding a threshold as historic sensor data; and
transmitting by the communication module at least one historic sensor data associated with one sensor along with live sensor data associated with the at least one sensor in a same advertising channel of the beacon message.

17. The method of claim 16, further comprising:
storing by the communication module consecutive sensor output data exceeding thresholds as a plurality of consecutive historic sensor date; and
transmitting by the communication module a plurality of the stored historic sensor data along with live sensor data in a single adverting channel beacon message.

18. The method of claim 15, wherein:
the at least one sensor is at least one of an accelerometer sensor, a temperature sensor, or a light sensor.

19. The method of claim 15, further comprising:
transmitting by the communication module a plurality of consecutive advertising channel beacon transmissions containing the historic data.

20. The method of claim 15, further comprising:
starting by the communication module an elapsed timer when a live sensor output value exceeds a threshold to track elapsed time since the occurrence of historic data corresponding to the live data of a sensor output value exceeding a threshold

21. The method of claim 15, further comprising:
transmitting by the communication module consecutive live data and historic data for a predetermined number of advertising channel transmissions.

22. The method of claim 15, further comprising:
providing the predetermined number of advertising channel transmissions each with a plurality of prior consecutive historic data.

23. The method of claim 15, further comprising:
a plurality of sensors, each responsive to a different exterior ambient event.

24. The method of claim 23, further comprising:
storing by the communication module as live data and historic data sensor output values exceeding a threshold associated with the sensor.

25. The method of claim 24, further comprising:
transmitting by the communication module a plurality of historic data with live data in one advertising channel transmission.

26. The method of claim 23, further comprising:
transmitting by the communication module a plurality of consecutive historic data and one live data in one advertising channel; and
transmitting by the communication module a plurality of consecutive historic data and live data of a different one of a plurality of sensors.
